(19) United States
(12) Patent Application Publication
(10) Pub. No.: US 2013/0311359 A1
(43) Pub. Date: Nov. 21, 2013

(54) TRIPLE-CLICK ACTIVATION OF A MONETIZING ACTION

(71) Applicants: Ofer ZINGER, Tel Aviv (IL); Ohad Gliksman, Tel Aviv (IL)

(72) Inventors: Ofer ZINGER, Tel Aviv (IL); Ohad Gliksman, Tel Aviv (IL)

(21) Appl. No.: 13/476,343

(22) Filed: May 21, 2012

(51) Int. Cl. G06F 3/01; G06Q 20/08

(52) U.S. Cl. 705/39; 715/760

(57) ABSTRACT

A method and product for triple-click activation of a monetizing action. The method comprising: detecting, by a web browser displaying a web page, a triple-click action by a user; and in response to said detection performing a monetizing action, wherein the monetizing action is based upon a context of the triple-click action. A client-side script comprising computer readable medium retaining program instructions executable by a web browser, wherein the client-side script is configured to be associated with an object of a web document using an instruction; wherein the client-side script is configured to cause the web browser to invoke a monetizing action in response to a user performing a triple-click action on the object, wherein the monetizing action is based upon the object; and wherein the web document is a HyperText Markup Language (HTML) document or an Small Web Format (SWF) document.

### TECHNICAL FIELD

The present disclosure relates web browsing in general, and to activation of monetizing actions by a user browsing a web page, in particular.

### BACKGROUND

The World Wide Web (hereinafter referred to as the “web”) is a collection of servers within the Internet from which specially formatted documents may be retrieved by means of a web browser. Typically, web documents, also referred to as web pages are formatted in the HyperText Markup Language (HTML), which supports formatted text display, hyperlinks between and within documents and a variety of multimedia elements, including graphics, audio, and video. It will be noted that web pages may be formatted using other languages as well, such as eXtnsible HTML (XHTML), Small Web Format (SWF) (e.g., used by Adobe™ Flash and similar technologies), or the like.

A web browser is a client application that allows a user to selectively retrieve and display HTML documents from the web, as well as to selectively follow hyperlinks. Web browsers, such as Google Chrome™, Microsoft Internet Explorer™, a Mozilla FireFox™, are configured to obtain a web page, such as by retrieving it from a web server over the Internet, rendering a display based on the content of the web page, and providing a user with the display. Web browsers may further enable a user to perform actions, such as clicking a hyperlink, selecting text in the web page, or the like, using an input device, such as a pointing device (e.g., a mouse), a keyboard, a touch-screen, or the like.

A web browser may have default actions defined with specific user actions, such as selecting a word upon which a double-click action is performed.

Web browsers may further be configured to execute client-side scripts which the web page includes. The client-side script may be, for example, embedded directly in the web page, linked to (e.g., using a Unified Resource Locator (URL) address) a file containing the code by the web page, or the like.

### BRIEF SUMMARY

One exemplary embodiment of the disclosed subject matter is a computer-implemented method performed by a computerized device, comprising: detecting, by a web browser displaying a web page, a triple-click action by a user; and in response to said detection performing a monetizing action, wherein the monetizing action is based upon a context of the triple-click action.

Another exemplary embodiment of the disclosed subject matter is a computer program product comprising: a non-transitory computer readable medium retaining program instructions, which instructions when read by a processor, cause the processor to performs the steps of: causing a web browser to detect a triple-click action in a web page; in response to said detection by the web browser, invoking a client-side script, wherein the client-side script is configured to perform a monetizing action based upon a context of the triple-click action.

Yet another exemplary embodiment of the disclosed subject matter is a client-side script embodied in a non-transitory computer readable medium, wherein the non-transitory computer readable medium retaining program instructions executable by a web browser, wherein the client-side script is configured to be associated with an object of a web document using an instruction; wherein the client-side script is configured to cause the web browser to invoke a monetizing action in response to a user performing a triple-click action on the object, wherein the monetizing action is based upon the object; and wherein the web document is a HyperText Markup Language (HTML) document or an Small Web Format (SWF) document.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a computerized environment in which the disclosed subject matter is used, in accordance with some exemplary embodiments of the subject matter;

FIG. 2 shows a block diagram of an apparatus, in accordance with some exemplary embodiments of the disclosed subject matter;

FIG. 3 shows a flowchart diagram of a method, in accordance with some exemplary embodiments of the disclosed subject matter; and

FIG. 4 shows an illustration of a rendered display, in accordance with some exemplary embodiments of the disclosed subject matter.

### DETAILED DESCRIPTION

The disclosed subject matter is described below with reference to flowchart illustrations and/or block diagrams of methods, apparatus (systems) and computer program products according to embodiments of the subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

One technical problem dealt with by the disclosed subject matter is to provide for a user-friendly manner of performing actions by users of web pages that would increase monetary return of web page owner. The user-friendly manner may not interfere with the manner in which the user normally interacts with a web browser.

Another technical problem is to provide a web page owner an ability to increase his or her potential monetary return by harvesting activities by users visiting the web site.

Yet another technical problem is to enable users to efficiently perform search activities with as few separate user actions as possible.

One technical solution is to have the web browser detect a triple-click action by the user and in response perform a monetizing action. The monetizing action may be based upon a context of the triple-click action.

A triple-click action is an action comprising three sequential click actions performed within a relatively small and predetermined timeframe. A click action may be a button click on a pointing device, such as a mouse, a press on a touch screen, or the like.

A context of the triple-click action may be an object on which the triple-click is performed, a selected text on which the triple-click action is performed, a word, a line of text, or a paragraph on which the triple-click action is performed, or the like.

In some exemplary embodiments, the context may be the web page upon which the triple-click action is performed, such as for example in case the triple-click action is not performed on any specific object of the web page. Additionally or alternatively, the context may be based on the object and the web page containing it. A context of a web page may be based on the text, images, and other objects comprised by the web page, as well as hyperlinks from the web page to other documents, links to the web page from other documents (e.g., web pages) and text of the links, or the like, characteristics of a site comprising the web page, or the like.

In some exemplary embodiments, the context may be non-textual information such as an image, a video stream or the like. Based upon the non-textual context, relevant keywords may be automatically determined, such as, for example, using machine learning, image processing algorithms, crowdsourcing or the like. Additionally or alternatively, relevant keywords may be identified based on HTML tags associated with the context, such as for example, URL address of the image/video, alt tag (i.e., alternate text tag), or the like.

Monetization actions may be any website monetization activity, such as providing a search feed relevant to the context, redirecting the user to purchase a product or service associated with the context, displaying commercials relevant to the context, or the like. In some exemplary embodiments, the monetization action may be through an affiliate program. As an example only, the monetization activity may be through a search feed and rewards that are associated with the search feed, such as Pay-Per-Click, Pay-Per-Impression, or similar rewards may be gained by that the search feed owner based on the user's activity. A portion of the reward may be shared with the source of traffic of the user. The source of traffic may be identified using referral identification, also referred to as referral id. The monetization action may therefore be performing a search query associated with a predetermined referral id.

In some exemplary embodiments, a portion of the reward may be shared with the user, such as in case the user installs a browser extension or using a web browser that is configured in accordance with the disclosed subject matter.

In some exemplary embodiments, the monetizing action may be performed in a different web browser window than the window displaying the web page. A new web browser window may also include a new tab in the same window of the web browser thereby allowing a user to choose between different web pages using a tab user interface.

Another technical solution is to provide a web site owner with the ability to selectively choose web pages in which to enable said triple-click detection. The web site owner may introduce to a source code of the web page, such as to an HTML file, an instruction that is operative to invoke a client-side script that performs the monetization action in response to a detection of the triple-click action in the web page. The client-side script may be embedded in the source code or may be included in it by reference, such as for example using a URL address. The web site owner may introduce an HTML tag which is configured to cause a client-side script to be activated in case a triple-click action is performed on any object that is enclosed by the HTML tag.

The client-side script may be provided by a third-party (also referred to as a script owner) and may be configured to determine a different referral id for different web pages and/or web sites. Any reward associated with the referral id may be shared by the third-party and the web page owner. In some exemplary embodiments, each party may receive a share of the reward based upon a-priori agreement between the parties.

In some exemplary embodiments, the functionality of the web browser in response to a triple-click may be selectively modified based upon an object of the web page on which the triple-click action is performed and/or based upon the web page being displayed. For example, the web browser may be normally configured to perform one action in response to a triple-click action by the user. Based upon the instruction introduced to the web page source code (e.g., the HTML tag), the functionality of the browser may be modified in response to relevant triple-click actions.

In some exemplary embodiments, a predetermined web browser may be provided that is configured to be responsive to triple-click actions and that is configured to always perform relevant monetizing actions. In some exemplary embodiments, the web browser functionality may be modified by the user, such as by installing a browser extension, such as a browser toolbar.

In some exemplary embodiments, in response to each triple-click action by the user that is detected, an appropriate monetizing action may be selected between a set of alternative monetizing actions. In some exemplary embodiments, the selection may be based on the context of the triple-click action; characteristics of the user such as geographic and demographic information, history associated with the user; a date and time (e.g., holiday or workday, noon or at night, etc.); a content of the web page, or the like.

One technical effect of utilizing the disclosed subject matter is to allow for user-friendly activation of monetizing actions.

Another technical effect is to allow an owner of a web page to control the operation of the user's web browser, so as to increase monetary reward for the web page owner.

Yet another technical effect is to identify context of user interest, which is based on the fact that the user is clicking it, and providing for monetizing action based upon such context.

Yet another technical effect is to modify behavior of the web browser thereby optionally causing users to unintentionally perform actions that may bring revenue to the web page owner.

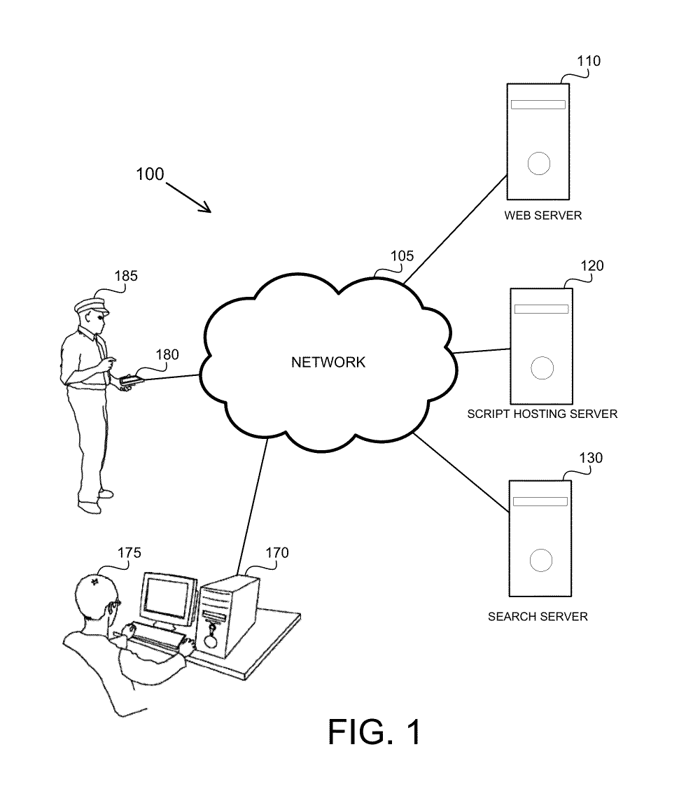

Referring now to FIG. 1 showing a computerized environment in which the disclosed subject matter is used, in accordance with some exemplary embodiments of the subject matter.

A Computerized Environment 100 may comprise a Network 105 of computerized devices, such as a LAN, a WAN, an Intranet, the Internet, or the like. Network 105 may be a wired network, a wireless network, a combination thereof, or the like.

Users, such as User 175 and User 185 may utilize computerized clients, such as Client 170 and Client 180. Clients 170, 180 may be any computerized device having a user interface, such as but not limited to, a desktop computer, a laptop computer, a Smartphone device, a Personal Digital Assistant (PDA), a tablet computer, or the like.

User 175 may browse the web using a web browser on Client 170. The web browser may be operative to obtain a web page, such as retained in an HTML file, from a Web Server 110. The Web Server 110 may be a computerized server that is configured to respond to a web page retrieval request by transmitting the web page over Network 105 to the requesting client.

The web browser may render the web page and display the rendered web page to the user. In some exemplary embodiments, the web page may comprise a client-side script which may or may not be embedded in the web page. Additionally or alternatively, the client-side script may be obtained, based on an instruction in the web page, from Web Server 110 or from a different server, such as Script Hosting Server 120.

Based on actions by User 175, the web browser may perform a monetizing action, such as invoking a search query on a search engine. The search engine may be, for example, executed by Search Server 130.

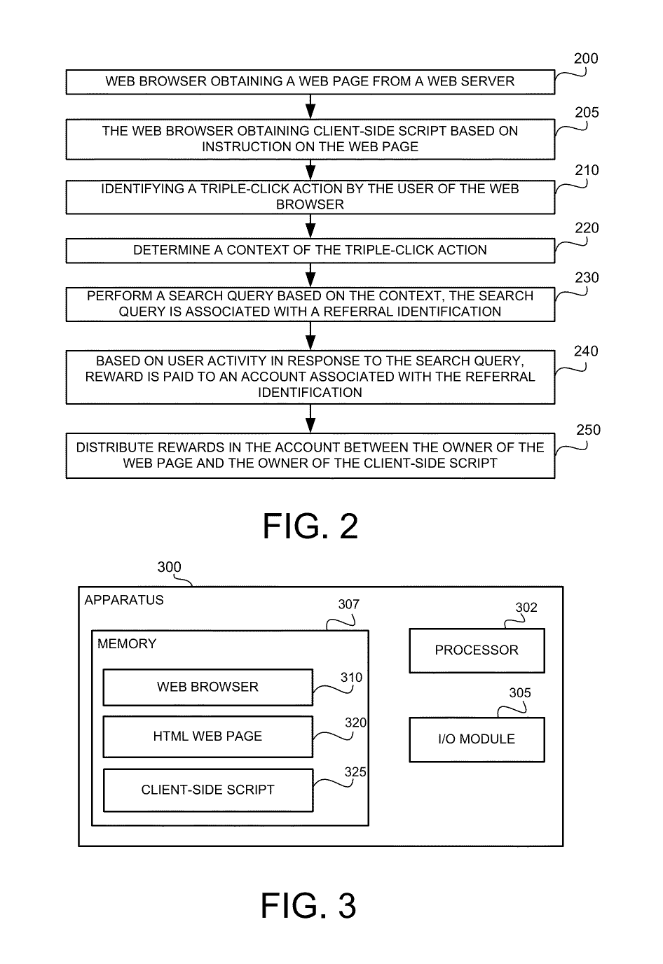

Referring now to FIG. 2 showing a flowchart diagram of a method, in accordance with some exemplary embodiments of the disclosed subject matter.

In Step 200, a web browser, such as operated by Client 170 or Client 180, may obtain a web page from a web server, such as 110 of FIG. 1. The web page may be rendered by the web browser to determine a rendered display of the web page.

In Step 205, the web browser may obtain a client-side script. The client-side script may be embedded as part of the web page. Additionally or alternatively, the client-side script may be obtained based on an instruction, such as an HTML tag instruction referring to a URL. The client-side script may be obtained from a server. The server may or may not be a third-party server that is not controlled by the web page owner, such as Script Hosting Server 120.

In Step 210, a triple-click action by the user may be identified. The web browser may be configured to always detect triple-click actions. Additionally or alternatively, the client-side script may cause the web browser to detect the triple-click action.

In Step 220, a context of the triple-click action may be determined. The context may be determined by the client-side script and/or by the web browser. The context may be associated with an HTML object being displayed in a location on which the user has performed the triple-click action. In some exemplary embodiments, based upon the coordinate in rendered display, a corresponding HTML object may be determined and used as a context. In some exemplary embodiments, if the user has selected a portion of the object (e.g., a portion of the text of a paragraph) and the triple-click action is performed on the selected portion, the context may be the selected portion.

In Step 230, in response to the triple-click action, a search query may be performed based on the context. In some exemplary embodiments, the search query may be associated with a referral id so as to allow monetary rewards to be gained.

In some exemplary embodiments, different monetary actions may be performed. Optionally, in response to a triple-click action, a suitable monetary action may be dynamically determined.

In some exemplary embodiments, the context may be textual or non-textual data. In some exemplary embodiments, non-textual data may be analyzed to determine textual data that may represent the non-textual data, such as keywords describing an image, a video stream, a sound stream, or the like.

In some exemplary embodiments, the search query or other monetary action may be performed in a new web browser window so as to avoid interrupting the user's activity on the web page. Additionally or alternatively, as a triple-click action may cause a new window to open, the user may perform multiple triple-click actions and have several new windows be opened.

In Step 240, and based on user activity in the window displaying the search feed, reward may be paid to an account associated with the referral id. As an example, in case the user clicks on a sponsored link, a pay-per-click reward may be paid to the owner of the search feed and a portion thereof may be attributed to the referral id. As another example, a pay-per-impression model may provide a reward for displaying the search feed. A portion of such reward may also be attributed to the referral id.

In Step 250, the rewards associated with the referral id may be distributed between the owner of the web page and the owner of the client-side script. In some exemplary embodiments, the owner of the search feed may or may not be the same as the owner of the client-side script.

In some exemplary embodiments, the initial share paid to the referral id may take into account the share of the client-side script owner. As an example, instead of a 5% share of referral fees as may be provided under affiliation programs, the fact that the referral is based on the client-side script may be taken into account, and if the reward is to be split in equal shares, the referral fee may instead be lowered to 2.5%.

Referring now to FIG. 3 showing an Apparatus 300 in accordance with some exemplary embodiments of the disclosed subject matter.

In some exemplary embodiments, Apparatus 300 may comprise a Processor 302. Processor 302 may be a Central Processing Unit (CPU), a microprocessor, an electronic circuit, an Integrated Circuit (IC) or the like. Processor 302 may be utilized to perform computations required by Apparatus 300 or any of it subcomponents.

In some exemplary embodiments of the disclosed subject matter, Apparatus 300 may comprise an Input/Output (I/O) module 305. The I/O module 305 may be utilized to provide an output to and receive input from a user, such as 175 of FIG. 1. In some exemplary embodiments, I/O Module 305 may be configured to display the rendered web page to the user. Additionally or alternatively, I/O Module 305 may be configured to receive input from the user, such as mouse clicks or taps on a touch screen, thereby enabling identification of a triple-click action. Additionally or alternatively, I/O Module 305 may provide an interface to a computerized network, such as 105 of FIG. 1.

In some exemplary embodiments, Apparatus 300 may comprise a Memory Unit 307. Memory Unit 307 may be a short-term storage device or long-term storage device. Memory Unit 307 may be a persistent storage or volatile storage. Memory Unit 307 may be a disk drive, a Flash disk, a Random Access Memory (RAM), a memory chip, or the like. In some exemplary embodiments, Memory Unit 307 may retain program code operative to cause Processor 302 to perform acts associated with any of the subcomponents of Apparatus 300. In some exemplary embodiments, Memory Unit 307 may retain program code operative to cause Processor 302 to perform acts associated with any of the steps in FIG. 2 above.

The components detailed below may be implemented as one or more sets of interrelated computer instructions, executed for example by Processor 302 or by another processor. The components may be arranged as one or more executable files, dynamic libraries, static libraries, methods, functions, services, or the like, programmed in any programming language and under any computing environment.

A Web Browser 310 may be configured to obtain web pages from servers in a computerized network, such as HTML Web Page 320. In response to obtaining HTML Web Page 320, it may be retained in Memory Unit 307. Web Browser 310 may be configured to render HTML Web Page 320 and provide a display, optional graphical display, thereof to the user. In some exemplary embodiments, Web Browser 310 may or may not have default functionality in response to a triple-click action. In some exemplary embodiments, Web Browser 310 may be configured to cause execution of client-side scripts, such as Client-Side Script 325, in accordance with instructions in the HTML Web Page 320.

In some exemplary embodiments, based upon instructions in the HTML Web Page 320 may comprise the Client-Side Script 325. In some exemplary embodiments, Client-Side Script 325 may be obtained from a server, such as the web server from which HTML Web Page 320 is obtained or from a third-party server.

Client-Side Script 325 may be configured to cause Web Browser 310 to invoke monetizing actions in response to triple-click actions by users, in accordance with the disclosed subject matter.

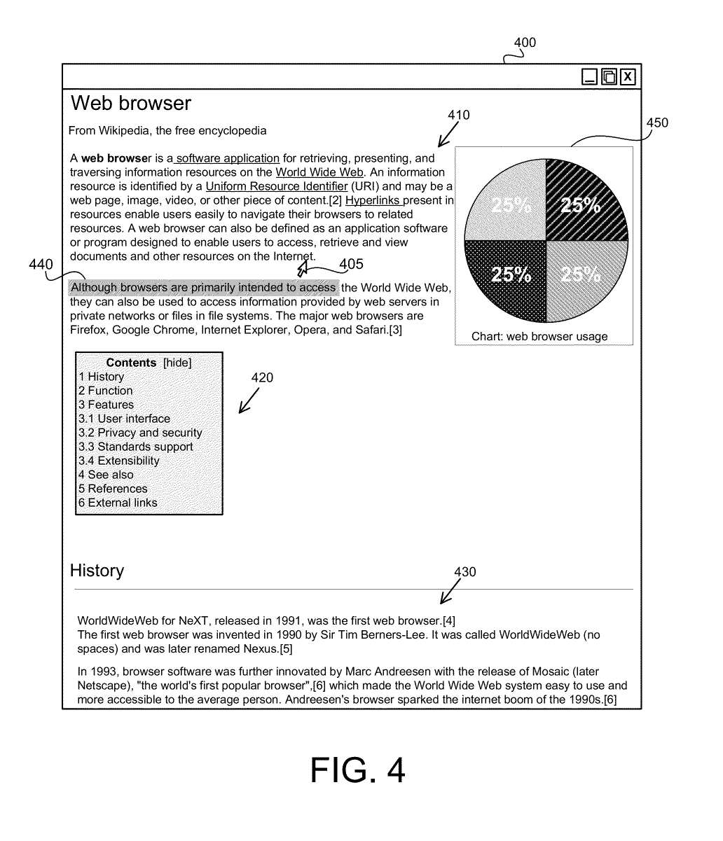

Referring now to FIG. 4 showing an illustration of a rendered display, in accordance with some exemplary embodiments of the disclosed subject matter.

Display 400 shows a rendered display of a web page (content of which is based on a Wikipedia™ web page), as determined by a web browser. Different visual objects are displayed including formatted text (having different font, styles, colors, thickness, size, or the like), hyperlinks, images, or the like.

In some exemplary embodiments, a user (not shown) may interact with the web browser using a pointing device. In some exemplary embodiments, a pointing indicator, such as Cursor 405, may indicate a location on which the user is pointing. Additionally or alternatively, the user may utilize a touch screen which may determine pointed coordination based on a location of the user's touch.

An object being displayed may be a Paragraph Section 410. Triple-click on

Paragraph section 410 may consider the entire paragraph as a context. Additionally or alternatively, a clicked word, sentence, line or the like may be considered as the context. In some exemplary embodiments, the context may take into account formatting of the text. For example, Paragraph Section 410 may be considered as associated with the bolded term “web browser”.

Box Section 420 may also be an object in the rendered display. In some exemplary embodiments, as well as History Section 430. Each of which may be considered a different object.

In some exemplary embodiments, each object may be optionally tagged with a predetermined HTML tag to cause the web browser to detect triple-click action on the object and cause monetization action based thereof.

In some exemplary embodiments, the HTML tag may be used on an container object, such as for example, HTML body tag which contains the entire content of the web page, paragraph tag which may comprise additional objects (e.g., image objects, text objects, table objects, or the like), or the like. Tagging the container object, may reduce manual definition by the web page's owner.

In some exemplary embodiments, the user may select a portion of the text, such as Selected Text 440. In some exemplary embodiments, in response to performing a triple-click action on or about on Selected Text 440, the context may be limited to the content text.

In some exemplary embodiments, an Image Object 450 may be responsive to triple-click action as well. A context of Image Object 450 may be determined based on associated text (e.g., “Chart: web browser usage”, “25%”, etc.), HTML tags of the object (e.g., alt tag, src tag, etc.), automatic inferred keywords based on an Artificial Intelligence mechanism, crowdsourcing information, or the like.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A computer-implemented method performed by a computerized device, comprising:
detecting, by a web browser displaying a web page, a triple-click action by a user; and
in response to said detection, performing a monetizing action, wherein the monetizing action is based upon a context of the triple-click action.

2. The computer-implemented method of claim 1, wherein the context of the triple-click action is a visible content of an object on which the triple-click action is performed, and wherein said performing a monetizing action comprises transmitting a request to a predetermined server, wherein the content of the request is based on the visible content of the object.

3. The computer-implemented method of claim 1, wherein the context of the triple-click action is a selected portion of a web document, which has been selected by the user of the web browser prior to the triple-click action being performed; the triple-click action being performed on the selected portion.

4. The computer-implemented method of claim 1, wherein said performing a monetizing action includes performing a search query, with a search engine, that is associated with a referral identification.

5. The computer-implemented method of claim 4, wherein the referral identification identifies at least two economic entities, one of which is an owner of the web page.

6. The computer-implemented method of claim 5, wherein monetary returns from the monetizing actions are divided between the at least two economic entities based on an agreed a-priori ratio.

7. The computer-implemented method of claim 1, wherein the displayed web page is configured to cause the web browser to invoke a client-side script in response to the triple-click action being performed; and wherein the client-side script is configured to perform the monetizing action in a new window of the web browser.

8. The computer-implemented method of claim 7, wherein the web page is an HyperText Markup Language (HTML) document; and wherein an object is associated with the client-side script using an HTML tag that is configured to invoke the client-side script upon performing the triple-click on the object.

9. The computer-implemented method of claim 7, wherein the web page is a document in Small Web Format (SWF), and wherein an object is associated with the client-side script using an SWF instruction.

10. The computer-implemented method of claim 1, wherein the web browser displaying a second web page performing a default action in response to the triple-click action, wherein the default action is different than the monetizing action.

11. The computer-implemented method of claim 10, wherein functionality of the web browser of the user is manipulated by an owner of the web page that decides whether or not to introduce a client-side script to the web page.

12. A computer program product comprising:
a non-transitory computer readable medium retaining program instructions, which instructions when read by a processor, cause the processor to performs the steps of:
causing a web browser to detect a triple-click action in a web page;
in response to said detection by the web browser, invoking a client-side script, wherein the client-side script is configured to perform a monetizing action based upon a context of the triple-click action.

13. The computer program product of claim 12, wherein the monetizing action is a search query which is identified with a referral identification, wherein the referral identification is associated with both an owner of the web page and an owner of the client-side script.

14. The computer program product of claim 12, wherein the web page is an HyperText Markup Language (HTML) document; and wherein an object is associated with the client-side script using an HTML tag that is configured to invoke the client-side script upon performing the triple-click on the object.

15. The computer program product of claim 14, wherein the web page comprises a plurality of objects and only a subset thereof are tagged with the HTML tag.

16. A client-side script embodied in a non-transitory computer readable medium, wherein the non-transitory computer readable medium retaining program instructions executable by a web browser, wherein the client-side script is configured to be associated with an object of a web document using an instruction;
wherein the client-side script is configured to cause the web browser to invoke a monetizing action in response to a user performing a triple-click action on the object, wherein the monetizing action is based upon the object; and
wherein the web document is a HyperText Markup Language (HTML) document or an Small Web Format (SWF) document.

17. The client-side script of claim 16, wherein the monetizing action is a search query which is identified with a referral identification, wherein the referral identification is associated with both an owner of the web page and an owner of the client-side script; and wherein the search query is based upon a content of the object.

18. The client-side script of claim 16, wherein the client-side script is configured to cause the web browser to invoke the monetizing action in a new window of the web browser.

19. The client-side script of claim 16, wherein the web browser is configured to perform a default action in response to a triple-click action by the user; and wherein the client-side script is configured to override said default action.

20. The client-side script of claim 19 enabling an owner of the document to override said default action of the web browser operated by the user.

21. A computer-implemented method performed by a computerized device, the method comprising:
detecting, by a web browser displaying a web page, a triple-click action by a user on an object in the web page, the object having visible content that is displayed by the web browser when the web page is displayed; and
in response to said detection, referring the user to a search engine by invoking a query to the search engine with respect to the visible content, the query indicating to the search engine a referral identification used for sharing revenues generated by the search engine by the referred user.
